(19) United States
(12) Patent Application Publication
(10) Pub. No.: US 2016/0196892 A1
(43) Pub. Date: Jul. 7, 2016

(54) CONDUCTIVE RESIN COMPOSITION AND TRANSPARENT CONDUCTIVE LAMINATED BODY

(71) Applicant: Nagase ChemteX Corporation, Osaka (JP)

(72) Inventors: Tatsuya OHORI, Hyogo (JP); Yasunori KURUSHIMA, Hyogo (JP); Takashi HASEGAWA, Hyogo (JP); Takahiro SAKURAI, Hyogo (JP)

(21) Appl. No.: 14/591,591

(22) Filed: Jan. 7, 2015

(51) Int. Cl. H01B 1/12; C09D 11/108; G06F 3/041; C09D 141/00; H01B 13/34; C09D 11/52; C09D 181/02

(52) U.S. Cl. CPC H01B 1/127; C09D 11/52; C09D 11/108; C09D 181/02; C09D 141/00; H01B 13/345; G06F 3/041

(57) ABSTRACT

Provided is a conductive resin composition suitable for forming a transparent conductive film with good appearance and excellent transparency. The conductive resin composition includes: (A) a conductive polymer; (B) a conductivity enhancer; (C) a binder; and (D) a thickener, the composition having a viscosity at 25° C. of 50 to 8000 dPa·s, and containing the thickener (D) in an amount of less than 200 parts by weight per 100 parts by weight of solids of the conductive polymer (A).

### TECHNICAL FIELD

The present invention relates to a conductive resin composition and a transparent conductive laminate, and further relates to a printing ink, a method for producing the transparent conductive laminate, a touch panel, and a touch sensor.

### BACKGROUND ART

In recent years the demand for transparent conductive laminates for use as transparent electrodes, which are essential components of touch panels or display elements for various electronic devices, has been increasing. Transparent conductive laminates include a transparent substrate and a transparent conductive film formed from a conductive resin containing a conductive polymer, which is stacked on the substrate. These transparent conductive films can be prepared by known methods, such as screen printing, offset printing, or pad printing.

Such printing methods, which do not require any complicated process, allow for easy patterning at low costs, and therefore have quite excellent productivity. On the other hand, these methods need the use of a highly viscous ink. Patent Literature 1 discloses a resin composition having a viscosity of 1 to 200 dPa·s prepared by preparing a solution or dispersion of a composite of poly(3,4-ethylenedioxythiophene) [PEDOT] and polystyrene sulfonic acid [PSS] ([PEDOT]/[PSS]) as a conductive polymer, and concentrating the solution or dispersion containing less than 2% by weight of [PEDOT]/[PSS] to a concentration exceeding 2% by weight, and optionally adding thereto a binder, a thickening agent, and a filler. Patent Literature 2 discloses a resin composition prepared by adding a crosslinkable polyacrylic acid as a thickener to an aqueous dispersion of the [PEDOT]/[PSS].

### CITATION LIST

### Patent Literature

Patent Literature 1: JP 2002-500408 T

Patent Literature 2: JP 2004-532307 T

### SUMMARY OF INVENTION

### Technical Problem

However, the method disclosed in Patent Literature 1 needs a step of concentrating the conductive polymer, resulting in an increase in the cost of the conductive resin composition. Also, the method disclosed in Patent Literature 2 can provide a composition with increased viscosity, but if even a slight excess of thickener, which is generally added in an increased amount in order to increase the resolution of printed articles obtained by screen printing or the like, is added, then the conductive polymer shows poor dispersion stability due to changes in the liquid state. Consequently, a precipitate is observed in the liquid resin composition, and if such a resin composition is applied on a substrate to prepare a transparent conductive film, the film has problems including a trace of the bar coater left on the film, and poor transparency.

### Solution to Problem

The present inventors have intensively studied to solve the above problems, and have found that the use of a conductive polymer aqueous dispersion that is more viscous than conventional ones as a conductive polymer provides a conductive resin composition in which no precipitate is observed and which can form a transparent conductive film with good appearance and excellent transparency. Thus, the present invention has been completed.

Specifically, the present invention relates to a conductive resin composition, comprising: (A) a conductive polymer; (B) a conductivity enhancer; (C) a binder; and (D) a thickener, the composition having a viscosity at 25° C. of 50 to 8000 dPa·s, and containing the thickener (D) in an amount of less than 200 parts by weight per 100 parts by weight of solids of the conductive polymer (A).

In the conductive resin composition of the present invention, the conductive polymer (A) is preferably a composite of poly(3,4-ethylenedioxythiophene) and polystyrene sulfonic acid.

In the conductive resin composition of the present invention, the conductive polymer (A) is preferably a 1% to 5% by weight conductive polymer aqueous dispersion having a viscosity at 25° C. of 5 to 500 dPa·s.

In the conductive resin composition of the present invention, the conductive polymer aqueous dispersion is preferably obtained without concentration.

In the conductive resin composition of the present invention, the binder (C) is preferably at least one selected from the group consisting of polyester resins, polyurethanes, epoxy resins, acrylic resins, alkoxysilane oligomers, and polyolefin resins.

In the conductive resin composition of the present invention, the thickener (D) is preferably at least one selected from the group consisting of polyacrylic acid resins, cellulose ether resins, polyvinylpyrrolidones, carboxyvinyl polymers, and polyvinyl alcohols.

The present invention relates to a printing ink, comprising the conductive resin composition of the present invention.

The present invention relates to a transparent conductive laminate, obtained by printing the printing ink of the present invention on a substrate, the laminate having a surface resistivity of 0.1 to 1000 Ω/sq and a total light transmittance of 50% or higher.

In the transparent conductive laminate of the present invention, the printing is preferably carried out by at least one means selected from the group consisting of screen printing, offset printing, and pad printing.

The present invention relates to a method for producing the transparent conductive laminate of the present invention, comprising printing the printing ink of the present invention on a substrate.

In the method for producing the transparent conductive laminate of the present invention, the printing is preferably carried out by at least one means selected from the group consisting of screen printing, offset printing, and pad printing.

The present invention relates to a touch panel or a touch sensor, comprising the transparent conductive laminate of the present invention.

### Advantageous Effects of Invention

The conductive resin composition of the present invention, which contains a highly viscous conductive polymer, has viscosity and rheology properties sufficient to be used in screen printing and the like even when only a small amount of thickener is used. Further, since the conductive resin composition contains an adjusted amount of thickener, higher viscosity properties can be obtained while the dispersion stability of the conductive polymer is maintained. Therefore, the transparent conductive film formed from the conductive resin composition of the present invention has good transparency and good electric conductivity, and fine patterns formed using the composition by screen printing or the like have excellent printing properties.

### DESCRIPTION OF EMBODIMENTS

The conductive resin composition of the present invention contains a conductive polymer (A), a conductivity enhancer (B), a binder (C), and a thickener (D), and has a viscosity at 25° C. of 50 to 8000 dPa·s.

### <(A) Conductive Polymer>

The conductive polymer (A) is a compounding ingredient which imparts electric conductivity to the transparent conductive film. The conductive polymer (A) is not particularly limited, and may be any of conventionally known conductive polymers. Specific examples include polythiophene, polypyrrole, polyaniline, polyacetylene, polyphenylene vinylene, and polynaphthalene, and derivatives of these. These may be used alone, or two or more of these may be used in combination. In particular, conductive polymers having at least one thiophene ring in the molecule are preferred because the molecule containing therewithin a thiophene ring is likely to be highly conductive. The conductive polymer (A) may be in the form of a composite with a dopant such as a polyanion.

Among the conductive polymers having at least one thiophene ring in the molecule, poly(3,4-disubstituted thiophenes) are more preferred because of their quite excellent conductivity and quite excellent chemical stability. When the conductive resin composition is a poly(3,4-disubstituted thiophene) or a composite of a poly(3,4-disubstituted thiophene) and a polyanion (dopant), the transparent conductive film can be formed at low temperatures in a short time with excellent productivity. The polyanion refers to a dopant for the conductive polymer and will be described in detail later.

The poly(3,4-disubstituted thiophene) is particularly preferably a poly(3,4-dialkoxythiophene) or poly(3,4-alkylenedioxythiophene). The poly(3,4-dialkoxythiophene) or poly(3,4-alkylenedioxythiophene) is preferably a cationic polythiophene having a recurring structural unit represented by the formula (I):

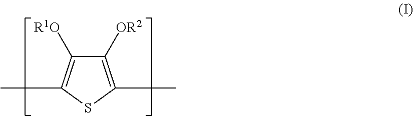

wherein R¹ and R² each independently represents hydrogen or a C₁₋₄ alkyl group, or R¹ and R² are joined to form a C₁₋₄ alkylene group. Examples of the C₁₋₄ alkyl group include, but are not limited to, methyl, ethyl, propyl, isopropyl, n-butyl, isobutyl, sec-butyl, and t-butyl. Examples of the C₁₋₄ alkylene group formed by joining R¹ and R² include, but are not limited to, methylene, 1,2-ethylene, 1,3-propylene, 1,4-butylene, 1-methyl-1,2-ethylene, 1-ethyl-1,2-ethylene, 1-methyl-1,3-propylene, and 2-methyl-1,3-propylene. Preferred among these are methylene, 1,2-ethylene, and 1,3-propylene, with 1,2-ethylene being more preferred. The hydrogens in the C₁₋₄ alkyl group or C₁₋₄ alkylene group may be partially substituted. The polythiophene containing a C₁₋₄ alkylene group is particularly preferably poly(3,4-ethylenedioxythiophene).

The conductive polymer preferably has a weight average molecular weight of 500 to 100000, more preferably 1000 to 50000, and most preferably 1500 to 20000. The conductive polymer having a weight average molecular weight of less than 500 cannot ensure the required viscosity for the composition prepared therefrom, and may provide reduced conductivity to the transparent conductive laminate prepared therefrom.

The dopant is preferably but not limited to a polyanion. The polyanion can form an ion pair with a polythiophene (derivative) to form a composite, thereby enabling the polythiophene (derivative) to be stably dispersed in water. Examples of the polyanion include, but are not limited to, carboxylic acid polymers (e.g. polyacrylic acid, polymaleic acid, polymethacrylic acid), and sulfonic acid polymers (e.g. polystyrene sulfonic acid, polyvinyl sulfonic acid, polyisoprene sulfonic acid). Moreover, the carboxylic acid polymer or sulfonic acid polymer may be a copolymer of a vinyl carboxylic acid or vinyl sulfonic acid and a polymerizable monomer such as acrylates or aromatic vinyl compounds (e.g. styrene and vinylnaphthalene). Among these, polystyrene sulfonic acid is particularly preferred.

The polystyrene sulfonic acid preferably has a weight average molecular weight of 20000 to 500000, and more preferably 40000 to 200000. If the polystyrene sulfonic acid having a molecular weight outside the range mentioned above is used, the polythiophene-based conductive polymer may have reduced dispersion stability in water. The weight average molecular weight is determined by gel permeation chromatography (GPC).

The composite of the conductive polymer (A) with the polyanion is preferably a composite of poly(3,4-ethylenedioxythiophene) and polystyrene sulfonic acid because of its particularly excellent transparency and conductivity.

The conductive polymer (A) may have any conductivity, and preferably has a conductivity of 0.01 S/cm or higher and more preferably 0.05 S/cm or higher because such a polymer provides sufficient conductivity to the transparent conductive film.

The conductive resin composition may contain any amount of the conductive polymer (A). The amount of the conductive polymer (A) in the transparent conductive laminate prepared therefrom is preferably 0.01 to 50.0 mg/m², and more preferably 0.1 to 10.0 mg/m². If the amount is less than 0.01 mg/m², the conductive polymer (A) content in the transparent conductive film may be too low to ensure sufficient conductivity for the transparent conductive film. If the amount is more than 50.0 mg/m², the conductive polymer (A) content in the transparent conductive film may be so high that the strength of the coating and the film-forming properties can be adversely affected.

The conductive polymer (A) preferably has a viscosity of 5 to 500 dPa·s, and more preferably 10 to 500 dPa·s, as measured at 25° C. as a 1% to 5% by weight aqueous dispersion, and preferably a 2% to 5% by weight aqueous dispersion. The conductive polymer having a viscosity of less than 5 dPa·s cannot ensure the required viscosity for the composition prepared therefrom. If the viscosity is more than 500 dPa·s, problems are likely to occur in that, for example, foams may be formed during the mixing or the conductive polymer is not uniformly miscible. The viscosity as used herein is determined using a B-type viscometer.

The conductive polymer (A) preferably has a thixotropic index (Ti) of 0.1 to 10, and more preferably 1 to 8, as measured at 25° C. as a 1% to 5% by weight aqueous dispersion, and preferably a 2% to 5% by weight aqueous dispersion. The composition prepared from the conductive polymer (A) having a thixotropic index within the range mentioned above can advantageously achieve the thixotropic index described later. The thixotropic index as used herein is defined as a ratio of a viscosity η₁ at a shear rate of 1 (1/s) to a viscosity η₁₀ at a shear rate of 10 (1/s) (Ti value=η₁/η₁₀), as determined at 25° C. using a rheometer.

The conductive polymer (A) preferably has a yield stress of 1 to 100 Pa, and more preferably 2 to 100 Pa, as measured at 25° C. as a 1% to 5% by weight aqueous dispersion, and preferably a 2% to 5% by weight aqueous dispersion. The composition prepared from the conductive polymer (A) having a yield stress within the range mentioned above can advantageously achieve the yield stress described later. The yield stress is calculated by measuring stress at 25° C. using a rheometer while varying the shear rate over the range of 0.01 (1/s) to 100 (1/s), followed by fitting the Casson equation:

√stress=√viscosity·√shear rate+√yield stress.

As an example of a method of preparing the conductive polymer (A), a method of preparing an aqueous dispersion of a composite of a polythiophene represented by the formula (I) and a dopant is explained. The aqueous dispersion of the composite can be prepared by the step of oxidatively polymerizing a 3,4-dialkoxythiophene represented by the formula (II) below in an aqueous solvent using an oxidant in the presence of a dopant.

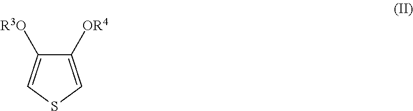

In the formula, R³ and R⁴ each independently represents hydrogen or a C₁₋₄ alkyl group, or R³ and R⁴ are joined to form a C₁₋₄ alkylene group. Examples of the C₁₋₄ alkyl group include, but are not limited to, methyl, ethyl, propyl, isopropyl, n-butyl, isobutyl, sec-butyl, and t-butyl. Examples of the C₁₋₄ alkylene group formed by joining R³ and R⁴ include, but are not limited to, methylene, 1,2-ethylene, 1,3-propylene, 1,4-butylene, 1-methyl-1,2-ethylene, 1-ethyl-1,2-ethylene, 1-methyl-1,3-propylene, and 2-methyl-1,3-propylene. Preferred among these are methylene, 1,2-ethylene, and 1,3-propylene, with 1,2-ethylene being more preferred. The hydrogens in the C₁₋₄ alkyl group or C₁₋₄ alkylene group may be partially substituted.

Polythiophenes can be prepared by oxidatively polymerizing monomers by chemical polymerization using various oxidants. The chemical polymerization is simple enough for mass production, and is therefore more suitable for industrial production than the conventional electrolytic polymerization.

Examples of the oxidant used in the chemical polymerization include, but are not limited to, oxidants containing a sulfonic acid compound as anion and a high valence transition metal as cation. Examples of high valence transition metal ions forming such oxidants include Cu²⁺, Fe³⁺, Al³⁺, Ce⁴⁺, W⁶⁺, Mo⁶⁺, Cr⁶⁺, Mn⁷⁺, and Sn⁴⁺. Preferred among these are Fe³⁺ and Cu²⁺. Specific examples of oxidants containing a transition metal cation include FeCl₃, Fe(ClO₄)₃, K₂CrO₇, alkali perborates, potassium permanganate, and copper tetrafluoroborate. Examples of oxidants other than the oxidants containing a transition metal cation include alkali persulfates, ammonium persulfate, and H₂O₂. Other examples include hypervalent compounds such as hypervalent iodine reagents.

The dopant such as polyanion is preferably used in an amount of 50 to 2000 parts by weight, and more preferably 100 to 1000 parts by weight, per 100 parts by weight of 3,4-dialkoxythiophene.

The solvent is an aqueous solvent, and particularly preferably water. A water-soluble solvent, such as alcohols (e.g. methanol, ethanol, 2-propanol, 1-propanol), acetone, or acetonitrile, may be added to water and used.

The conductive polymer (A) having the above viscosity can be prepared by controlling the conditions so as to increase the reaction temperature, decrease the pH of the reaction system, slow down the stirring rate, reduce the concentration of dissolved oxygen, and/or increase the reaction concentration, as compared to the conditions for the preparation of conductive polymers commonly and widely employed. It is considered that the control of these conditions enables the resulting conductive polymer to have a higher molecular weight or agglomerate and therefore to achieve the above viscosity and the above thixotropic index/yield stress.

The temperature of the oxidative polymerization reaction is preferably 0 to 40° C., and more preferably 5 to 35° C. If the temperature is lower than 0° C., the polymerization reaction of the conductive polymer may not sufficiently proceed, resulting in insufficient conductivity. If the temperature is higher than 40° C., the polymerization reaction tends to proceed too much, resulting in poor dispersion stability.

The pH during the polymerization is preferably 0.1 to 5.0, and more preferably 0.1 to 3.0. If the pH is lower than 0.1, the polymerization reaction may proceed too much, resulting in poor dispersion stability. If the pH is higher than 5.0, the polymerization reaction of the conductive polymer tends not to sufficiently proceed, resulting in insufficient conductivity.

The stirring rate of the reaction mixture during the polymerization is preferably 100 to 1000 rpm, and more preferably 200 to 500 rpm. If the stirring rate is less than 100 rpm, the polymerization reaction may proceed too much, resulting in poor dispersion stability. If the stirring rate is more than 1000 rpm, the polymerization reaction of the conductive polymer tends not to sufficiently proceed, resulting in insufficient conductivity.

The reaction concentration of the reaction mixture during the polymerization is preferably 1 to 10%, and more preferably 1 to 6%. If the reaction concentration is less than 1%, the polymerization reaction of the conductive polymer may not sufficiently proceed, resulting in insufficient conductivity. If the reaction concentration is more than 10%, the polymerization reaction tends to proceed too much, resulting in poor dispersion stability.

The conductive polymer (A) prepared as mentioned above has an average particle size of 60 to 10000 nm, preferably 70 to 5000 nm, due to an increase in molecular weight or secondary agglomeration. The average particle size as used herein is determined by dynamic light scattering (DLS).

In the present invention, the aqueous dispersion of the conductive polymer (A) prepared by the aforementioned process can be used as a raw material to be compounded, without concentration.

### <(B) Conductivity Enhancer>

A conductivity enhancer (B) is added in order to enhance the electric conductivity of the transparent conductive film formed from the conductive resin composition of the present invention. The conductivity enhancer (B) is evaporated by heating during the formation of the transparent conductive film. This is considered to control alignment of the conductive polymer (A) to enhance the conductivity of the transparent conductive film. Further, the use of the conductivity enhancer (B) allows the amount of the conductive polymer (A) to be reduced while maintaining the surface resistivity, as compared to when no conductivity enhancer (B) is used. Therefore, transparency is advantageously improved.

To ensure conductivity needed for transparent conductive films, the conductivity enhancer (B) is preferably at least one selected from the group consisting of the compounds (i) to (vii):

(i) a compound having a boiling point of 60° C. or higher and containing at least one ketone group in the molecule;
(ii) a compound having a boiling point of 100° C. or higher and containing at least one ether group in the molecule;
(iii) a compound having a boiling point of 100° C. or higher and containing at least one sulfinyl group in the molecule;
(iv) a compound having a boiling point of 100° C. or higher and containing at least one amide group in the molecule;
(v) a compound having a boiling point of 50° C. or higher and containing at least one carboxyl group in the molecule;
(vi) a compound having a boiling point of 100° C. or higher and containing two or more hydroxyl groups in the molecule; and
(vii) a compound having a boiling point of 100° C. or higher and containing at least one lactam group in the molecule.

Examples of the compound (i) having a boiling point of 60° C. or higher and containing at least one ketone group in the molecule include isophorone, propylene carbonate, γ-butyrolactone, β-butyrolactone, and 1,3-dimethyl-2-imidazolidinone. These may be used alone, or two or more of these may be used in combination.

Examples of the compound (ii) having a boiling point of 100° C. or higher and containing at least one ether group in the molecule include diethylene glycol monomethyl ether, diethylene glycol monoethyl ether, diethylene glycol dimethyl ether, 2-phenoxyethanol, dioxane, morpholine, 4-acryloylmorpholine, N-methylmorpholine N-oxide, 4-ethylmorpholine, and 2-methoxyfuran. These may be used alone, or two or more of these may be used in combination.

Examples of the compound (iii) having a boiling point of 100° C. or higher and containing at least one sulfinyl group in the molecule include dimethyl sulfoxide.

Examples of the compound (iv) having a boiling point of 100° C. or higher and containing at least one amide group in the molecule include N,N-dimethylacetamide, N-methylformamide, N,N-dimethylformamide, acetamide, N-ethylacetamide, N-phenyl-N-propylacetamide, and benzamide. These may be used alone, or two or more of these may be used in combination.

Examples of the compound (v) having a boiling point of 50° C. or higher and containing at least one carboxyl group in the molecule include acrylic acid, methacrylic acid, methanoic acid, ethanoic acid, propanoic acid, butanoic acid, pentanoic acid, hexanoic acid, octanoic acid, decanoic acid, dodecanoic acid, benzoic acid, p-toluic acid, p-chlorobenzoic acid, p-nitrobenzoic acid, 1-naphthoic acid, 2-naphthoic acid, phthalic acid, isophthalic acid, oxalic acid, malonic acid, succinic acid, adipic acid, maleic acid, and fumaric acid. These may be used alone, or two or more of these may be used in combination.

Examples of the compound (vi) having a boiling point of 100° C. or higher and containing two or more hydroxyl groups in the molecule include ethylene glycol, diethylene glycol, propylene glycol, trimethylene glycol, β-thiodiglycol, triethylene glycol, tripropylene glycol, 1,4-butanediol, 1,5-pentanediol, 1,3-butanediol, 1,6-hexanediol, neopentyl glycol, catechol, cyclohexanediol, cyclohexanedimethanol, glycerin, erythritol, isomalt, lactitol, maltitol, mannitol, sorbitol, xylitol, and sucrose. These may be used alone, or two or more of these may be used in combination.

Examples of the compound (vii) having a boiling point of 100° C. or higher and containing at least one lactam group in the molecule include N-methylpyrrolidone, β-lactam, γ-lactam, δ-lactam, ε-caprolactam, and laurolactam. These may be used alone, or two or more of these may be used in combination.

When the conductivity enhancer (B) has a boiling point of not lower than a specific temperature, the conductivity enhancer (B) will be gradually volatilized by heating during the formation of the transparent conductive film. This volatilization process is considered to result in the alignment of the conductive polymer (A) being favorably controlled in terms of conductivity, so that conductivity is enhanced. On the other hand, if the conductivity enhancer (B) has a boiling point lower than the specific temperature, it is considered that the conductivity enhancer (B) evaporates so rapidly that the alignment of the conductive polymer (A) cannot sufficiently be controlled, resulting in no improvement in conductivity.

Moreover, although not limited thereto, the conductivity enhancer (B) preferably has solubility parameters (SP values) in the following ranges: δ_{D}=12 to 30, δ_{H}=3 to 30, δ_{P}=5 to 30, and δ_{D}+δ_{H}+δ_{P}=35 to 70, and more preferably: δ_{D}=15 to 25, δ_{H}=10 to 25, δ_{P}=10 to 25, and δ_{D}+δ_{H}+δ_{P}=35 to 70.

The SP values as used herein refer to Hansen solubility parameters in which the solubility of substances is described using three parameters, the dispersion component δ_{D}, the polar component δ_{H}, and the hydrogen bonding component δ_{P}. It is considered that the addition of the conductivity enhancer (B) having SP values within the ranges mentioned above allows the conductive polymer (A) to be pseudo-dissolved to promote alignment of the polymer (A) during the evaporation. On the other hand, the conductivity enhancer (B) having SP values outside the ranges mentioned above is less likely to interact with the conductive polymer (A) and thus may not sufficiently show the effect of enhancing conductivity by controlling the alignment.

Furthermore, the conductivity enhancer (B) having SP values within the ranges mentioned above is highly compatible with the conductive polymer (A), and thus can enhance stability of the dispersion of the conductive polymer (A).

Examples of the conductivity enhancer (B) having SP values in the following ranges: δ_{D}=12 to 30, δ_{H}=3 to 30, δ_{P}=5 to 30, and δ_{D}+δ_{H}+δ_{P}=35 to 70 include, but are not limited to, isocyanate (δ_{D}=15.8, δ_{H}=10.5, δ_{P}=13.6), methyl isothiocyanate (δ_{D}=17.3, δ_{H}=16.2, δ_{P}=10.1), trimethyl phosphate (δ_{D}=15.7, δ_{H}=10.5, δ_{P}=10.2), 2-methyllactonitrile (δ_{D}=16.6, δ_{H}=12.2, δ_{P}=15.5), ephedrine (δ_{D}=18.0, δ_{H}=10.7, δ_{P}=24.1), thiourea (δ_{D}=20.0, δ_{H}=19.4, δ_{P}=14.8), carbamonitrile (δ_{D}=15.5, δ_{H}=27.6, δ_{P}=16.8), ethylene cyanohydrin (δ_{D}=17.2, δ_{H}=18.8, δ_{P}=17.6), and pyrazole (δ_{D}=20.2, δ_{H}=10.4, δ_{P}=12.4). These may be used alone, or two or more of these may be used in combination.

Furthermore, the compounds (i) to (vii) having SP values within the ranges mentioned above can be used as the conductivity enhancer (B).

The amount of the conductivity enhancer (B) is preferably but not limited to 5 to 2000 parts by weight, and more preferably 10 to 1500 parts by weight, per 100 parts by weight of solids of the conductive polymer (A). If the amount is less than 5 parts by weight, the conductivity-improving effect may not be sufficiently exerted by adding the conductivity enhancer (B). Conversely, if the amount is more than 2000 parts by weight, the amount of the conductive polymer (A) in the conductive resin composition of the present invention becomes relatively small, which may result in the transparent conductive film having insufficient conductivity.

### <(C) Binder>

A binder (C) is added in order to bind the compounding ingredients of the conductive resin composition of the present invention to one another to more reliably form a transparent conductive film (including conductive patterns). The binder (C) is preferably but not limited to at least one selected from the group consisting of, for example, polyester resins, polyurethanes, epoxy resins, acrylic resins, alkoxysilane oligomers, and polyolefin resins.

The polyester resin is not particularly limited as long as it is a high-molecular compound prepared by polycondensation of a compound having two or more carboxyl groups in the molecule and a compound having two or more hydroxyl groups. Examples of the polyester resin include polyethylene terephthalate, polytrimethylene terephthalate, polybutylene terephthalate, polyethylene naphthalate, and polybutylene naphthalate. These may be used alone, or two or more of these may be used in combination.

The polyurethane is not particularly limited as long as it is a high-molecular compound prepared by copolymerization of a compound containing an isocyanate group and a compound containing a hydroxyl group. Examples of the polyurethane include ester/ether polyurethanes, ether polyurethanes, polyester polyurethanes, carbonate polyurethanes, and acrylic polyurethanes. These may be used alone, or two or more of these may be used in combination.

Examples of the epoxy resin include bisphenol A, bisphenol F, and phenol novolac epoxy resins; polyfunctional tetrakis(hydroxyphenyl)ethane or tris(hydroxyphenyl)methane epoxy resins which have a large number of benzene rings; biphenyl, triphenolmethane, naphthalene, orthonovolac, dicyclopentadiene, amino phenol, and alicyclic epoxy resins; and silicone epoxy resins. These may be used alone, or two or more of these may be used in combination.

Examples of the acrylic resin include, but are not limited to, (meth)acrylic resins and vinyl ester resins. The acrylic resin may be any polymer that contains as a monomer unit a polymerizable monomer containing an acid group, such as carboxyl, acid anhydride, sulfonic acid, or phosphoric acid group. Such acrylic resins include homopolymers or copolymers of the polymerizable monomers containing an acid group, and copolymers of the polymerizable monomers containing an acid group and copolymerizable monomers. These may be used alone, or two or more of these may be used in combination.

The (meth)acrylic resin may be polymerized with a copolymerizable monomer, provided that the resin contains a (meth)acrylic monomer as a main monomer unit (for example, 50 mol % or more), and also provided that at least one of the (meth)acrylic monomer and the copolymerizable monomer contains an acid group. Examples of the (meth)acrylic resin include the acid group-containing (meth)acrylic monomers [e.g. (meth)acrylic acid, sulfoalkyl (meth)acrylates, sulfonic acid group-containing (meth)acrylamides] or copolymers thereof; copolymers of (meth)acrylic monomers optionally containing the acid group, with other polymerizable monomers containing the acid group [e.g., other polymerizable carboxylic acids, polymerizable polyhydric carboxylic acids or anhydrides thereof, and vinyl aromatic sulfonic acids] and/or the copolymerizable monomers [e.g. alkyl (meth)acrylates, glycidyl (meth)acrylate, (meth)acrylonitrile, aromatic vinyl monomers]; copolymers of other polymerizable monomers containing the acid group and copolymerizable (meth)acrylic monomers [e.g. alkyl (meth)acrylates, hydroxyalkyl (meth)acrylates, glycidyl (meth)acrylates, (meth)acrylonitrile]; rosin modified urethane acrylates; specially modified acrylic resins; urethane acrylates; epoxy acrylates; and urethane acrylate emulsions.

Preferred among these (meth)acrylic resins are (meth)acrylic acid/(meth)acrylic acid ester polymers (e.g. acrylic acid/methyl methacrylate copolymers), (meth)acrylic acid/(meth)acrylic acid ester/styrene copolymers (e.g. acrylic acid/methyl methacrylate/styrene copolymers) and the like.

Examples of the alkoxysilane oligomer include higher molecular weight alkoxysilane oligomers formed by condensation of alkoxysilane monomers represented by the formula (III) below, and having at least one siloxane bond (Si—O—Si) per molecule.

SiR₄ (III)

In the formula, R represents hydrogen, hydroxyl, a C₁₋₄ alkoxy group, an optionally substituted alkyl group, or an optionally substituted phenyl group, provided that at least one of the four Rs is a C₁₋₄ alkoxy group or hydroxyl.

The alkoxysilane oligomer may have any structure which may be linear or branched. Moreover, the alkoxysilane oligomer may be formed from a compound represented by the formula (III) alone or a combination of two or more of such compounds. The weight average molecular weight of the alkoxysilane oligomer is preferably but not limited to more than 152 but not more than 4000, more preferably 500 to 2500, and still more preferably 500 to 1500. The weight average molecular weight as used herein is determined by gel permeation chromatography (GPC).

Examples of the polyolefin resin include, but are not limited to, chlorinated polypropylenes, non-chlorinated polypropylenes, chlorinated polyethylenes, and non-chlorinated polyethylenes. These may be used alone, or two or more of these may be used in combination.

The amount of the binder (C) is preferably but not limited to 0.1 to 1000 parts by weight, and more preferably 5 to 500 parts by weight, per 100 parts by weight of solids of the conductive polymer (A). If the amount is less than 0.1 parts by weight, the resulting transparent conductive laminate may have reduced strength. If the amount is more than 1000 parts by weight, the amount of the conductive polymer (A) in the conductive resin composition becomes relatively small, which may make it impossible to ensure, sufficient conductivity in the resulting transparent conductive film.

### <(D) Thickener>

A thickener (D) is added in order to adjust the viscosity and rheology properties of the conductive resin composition. The use of a thickener enables the conductive resin composition to have a higher viscosity which cannot be achieved by the viscosity increase due to the conductive polymer (A).

The thickener (D) is preferably but not limited to at least one selected from the group consisting of, for example, polyacrylic acid resins, cellulose ether resins, polyvinylpyrrolidones, carboxyvinyl polymers, and polyvinyl alcohols. Such thickeners are available commercially as, for example, CARBOPOL ETD-2623 (crosslinkable polyacrylic acid, produced by B.F. Goodrich Company), GE-167 (copolymer of N-vinylacetamide and acrylic acid, produced by Showa Denko K.K.), JURYMER (polyacrylic acid, produced by Nihon Junyaku Co., Ltd.), and polyvinylpyrrolidone K-90 (polyvinylpyrrolidone, produced by NIPPON SHOKUBAI CO., LTD.). These may be used alone, or two or more of these may be used in combination.

The reason why these compounds are preferred as the thickener (D) is that these thickeners are quite excellent in compatibility with the conductive polymer (A), and the excellent compatibility provides the following effects:

(1) providing excellent dispersion stability to the conductive polymer (A), resulting in excellent storage stability;
(2) reducing haze and enhancing transparency;
(3) improving the adhesion to substrates to be printed;
(4) being able to form fine conductive patterns more precisely;
(5) providing improved wet-heat resistance to the conductive resin composition containing the polymer and thickener; and
(6) being suitable for inks for screen printing for the reasons (1) to (5).

The amount of the thickener (D) is preferably but not limited to less than 200 parts by weight, and more preferably less than 100 parts by weight, per 100 parts by weight of solids of the conductive polymer (A). If the amount is more than 200 parts by weight, precipitates tend to be formed, causing clogging of the printing plate and an increase in haze.

### <Optional Components>

The conductive resin composition of the present invention may optionally contain other components in addition to the conductive polymer (A), the conductivity enhancer (B), the binder (C), and the thickener (D), as long as they do not impair the objectives of the present invention. Examples of other components include solvents, crosslinking agents, catalysts, water-soluble antioxidants, surfactants and/or leveling agents, metal nanowires, defoaming agents, and neutralizers.

Examples of solvents include, but are not limited to, water; alcohols such as methanol, ethanol, 2-propanol, 1-propanol, and glycerin; ethylene glycols such as ethylene glycol, diethylene glycol, triethylene glycol, and tetraethylene glycol; glycol ethers such as ethylene glycol monomethyl ether, diethylene glycol monomethyl ether, ethylene glycol diethyl ether, and diethylene glycol dimethyl ether; glycol ether acetates such as ethylene glycol monoethyl ether acetate, diethylene glycol monoethyl ether acetate, and diethylene glycol monobutyl ether acetate; propylene glycols such as propylene glycol, dipropylene glycol, and tripropylene glycol; propylene glycol ethers such as propylene glycol monomethyl ether, propylene glycol monoethyl ether, dipropylene glycol monomethyl ether, dipropylene glycol monoethyl ether, propylene glycol dimethyl ether, dipropylene glycol dimethyl ether, propylene glycol diethyl ether, and dipropylene glycol diethyl ether; propylene glycol ether acetates such as propylene glycol monomethyl ether acetate, propylene glycol monoethyl ether acetate, dipropylene glycol monomethyl ether acetate, and dipropylene glycol monoethyl ether acetate; tetrahydrofuran; acetone; and acetonitrile. These solvents may be used alone, or two or more of these may be used in combination.

The solvent is preferably water or a mixture of water and an organic solvent. When the conductive resin composition of the present invention contains water as the solvent, the amount of water is preferably but not limited to 20 to 1000000 parts by weight, and more preferably 200 to 500000 parts by weight, per 100 parts by weight of solids of the conductive polymer (A). The conductive resin composition containing less than 20 parts by weight of water may have increased viscosity and be difficult to handle. If the amount of water is more than 1000000 parts by weight, the resulting solution may have too a low concentration which makes it difficult to adjust the thickness of the transparent conductive film.

When the conductive resin composition contains a mixture of water and an organic solvent as the solvent, the organic solvent is preferably at least one selected from the group consisting of methanol, ethanol, 2-propanol, glycerin, ethylene glycol, diethylene glycol, triethylene glycol, and tetraethylene glycol. The amount of the organic solvent is preferably but not limited to 20 to 700000 parts by weight, and more preferably 200 to 350000 parts by weight, per 100 parts by weight of solids of the conductive polymer. Moreover, the ratio of water to the organic solvent (water:organic solvent) by weight is preferably 100:0 to 5:95, and more preferably 100:0 to 30:70.

It is preferred that the solvent should not remain in the transparent conductive laminate formed from the conductive resin composition. It should be noted that the term “solvent” is used herein to include both those which completely dissolve all the components of the conductive resin composition, that is, “solvents” and those which disperse the insoluble components, that is, “dispersing media,” without drawing any distinction between them.

By adding a crosslinking agent, the binder (C) can be crosslinked so that the strength of the transparent conductive film formed from the conductive resin composition can be further enhanced.

Examples of the crosslinking agent include, but are not limited to, melamine, polycarbodiimide, polyoxazoline, polyepoxy, polyisocyanate, and polyacrylate crosslinking agents. These crosslinking agents may be used alone, or two or more of these may be used in combination.

When a crosslinking agent is used, the catalyst for crosslinking the binder (C) may be an acid group in the dopant or an additional organic acid or inorganic acid added. In addition, a heat sensitive acid generator, radiation sensitive acid generator, electromagnetic wave sensitive acid generator or the like may be added.

Examples of the catalyst include, but are not limited to, photopolymerization initiators and heat polymerization initiators which are commonly used in the art. When an acrylic resin is used as the binder (C), the catalyst is preferably a photopolymerization initiator.

The addition of a surfactant and/or leveling agent can provide improved leveling properties to the composition for forming the transparent conductive film, and such a conductive resin composition can be used to form a uniform transparent conductive film. In the present invention, one compound may serve as both a surfactant and a leveling agent.

The surfactant is not particularly limited as long as it has the effect of improving leveling properties. Specific examples include siloxane compounds such as polyether-modified polydimethylsiloxanes, polyether-modified siloxanes, polyether ester-modified, hydroxyl group-containing polydimethylsiloxanes, polyether-modified, acrylic group-containing polydimethylsiloxanes, polyester-modified, acrylic group-containing polydimethylsiloxanes, perfluoropolydimethylsiloxanes, perfluoropolyether-modified polydimethylsiloxanes, and perfluoropolyester-modified polydimethylsiloxanes; fluorine-containing organic compounds such as perfluoroalkyl carboxylic acids and perfluoroalkyl polyoxyethylene ethanols; polyether compounds such as polyoxyethylene alkyl phenyl ethers, propylene oxide polymers, and ethylene oxide polymers; carboxylates such as coconut fatty acid amine salts and gum rosin; ester compounds such as castor oil sulfates, phosphates, alkyl ether sulfates, sorbitan fatty acid esters, sulfonates, and succinates; sulfonate compounds such as alkyl aryl sulfonic acid amine salts and dioctyl sodium sulfosuccinate; phosphate compounds such as sodium lauryl phosphate; amide compounds such as coconut fatty acid ethanolamide; and acrylic compounds. These surfactants may be used alone, or two or more of these may be used in combination. Among these, siloxane compounds and fluorine-containing organic compounds are preferred because they significantly produce the effect of improving leveling properties.

Examples of the leveling agent include, but are not limited to, siloxane compounds such as polyether-modified polydimethylsiloxanes, polyether-modified siloxanes, polyether ester-modified, hydroxyl group-containing polydimethylsiloxanes, polyether-modified, acrylic group-containing polydimethylsiloxanes, polyester-modified, acrylic group-containing polydimethylsiloxanes, perfluoropolydimethylsiloxanes, perfluoropolyether-modified polydimethylsiloxanes, and perfluoropolyester-modified polydimethylsiloxanes; fluorine-containing organic compounds such as perfluoroalkyl carboxylic acids and perfluoroalkyl polyoxyethylene ethanols; polyether compounds such as polyoxyethylene alkyl phenyl ethers, propylene oxide polymers, and ethylene oxide polymers; carboxylates such as coconut fatty acid amine salts and gum rosin; ester compounds such as castor oil sulfates, phosphates, alkyl ether sulfates, sorbitan fatty acid esters, sulfonates, and succinates; sulfonate compounds such as alkyl aryl sulfonic acid amine salts and dioctyl sodium sulfosuccinate; phosphate compounds such as sodium lauryl phosphate; amide compounds such as coconut fatty acid ethanolamide; and acrylic compounds. These leveling agents may be used alone, or two or more of these may be used in combination.

A water-soluble antioxidant may be added to enhance heat resistance and wet-heat resistance of the transparent conductive film formed from the composition for forming the transparent conductive film.

Examples of the water-soluble antioxidant include, but are not limited to, reductive water-soluble antioxidants and non-reductive water-soluble antioxidants.

Examples of the reductive water-soluble antioxidant include compounds containing a lactone ring substituted with two hydroxyl groups, such as L-ascorbic acid, sodium L-ascorbate, potassium L-ascorbate, D(−)-isoascorbic acid (erythorbic acid), sodium erythorbate, and potassium erythorbate; monosaccharides and disaccharides (excluding sucrose), such as maltose, lactose, cellobiose, xylose, arabinose, glucose, fructose, galactose, and mannose; flavonoids such as catechin, rutin, myricetin, quercetin, kaempferol, and SANMELIN™ Y-AF; compounds having two or more phenolic hydroxy groups, such as curcumin, rosmarinic acid, chlorogenic acid, hydroquinone, 3,4,5-trihydroxybenzoic acid, and tannic acid; and compounds containing a thiol group, such as cysteine, glutathione, and pentaerythritol tetrakis(3-mercaptobutyrate).

Examples of the non-reductive water-soluble antioxidant include compounds that absorb ultraviolet light causing oxidative degradation, such as phenyl imidazole sulfonic acid, phenyl triazole sulfonic acid, 2-hydroxypyrimidine, phenyl salicylate, and sodium 2-hydroxy-4-methoxybenzophenone-5-sulfonate.

These water-soluble antioxidants may be used alone, or two or more of these may be used in combination.

In particular, the water-soluble antioxidant is preferably at least one compound selected from the group consisting of compounds containing a lactone ring substituted with two hydroxyl groups and compounds having two or more phenolic hydroxyl groups, and more preferably L-ascorbic acid, D(−)-isoascorbic acid, SANMELIN™ Y-AF, or tannic acid.

When the conductive resin composition of the present invention contains the water-soluble antioxidant, the amount of the water-soluble antioxidant is preferably but not limited to 0.001 to 500 parts by weight, more preferably 0.01 to 250 parts by weight, and still more preferably 0.05 to 100 parts by weight, per 100 parts by weight of solids of the conductive polymer (A). If the amount of the water-soluble antioxidant is less than 0.001 parts by weight, the transparent conductive film formed from the conductive resin composition may not have sufficiently improved heat resistance and wet-heat resistance. Conversely, if the amount thereof is more than 500 parts by weight, the conductive polymer (A) content in the transparent conductive film formed from the conductive resin composition becomes small, which may make it impossible to ensure sufficient conductivity in the transparent conductive film.

A metal nanowire may be added to enhance conductivity of the transparent conductive film formed from the conductive resin composition of the present invention.

Examples of the metal nanowire include elemental metals and metal-containing compounds. Examples of the elemental metals include, but are not limited to, silver, copper, silver, iron, cobalt, nickel, zinc, ruthenium, rhodium, palladium, cadmium, osmium, iridium, and platinum. Examples of the metal-containing compounds include, but are not limited to, compounds containing the metals mentioned above. These metal nanowires may be used alone, or two or more of these may be used in combination.

The metal nanowire is preferably at least one selected from the group consisting of silver nanowires, copper nanowires, and gold nanowires because they have a free electron concentration higher than other metal nanowires and are highly conductive.

Since the conductive resin composition of the present invention is an acidic composition, a basic compound may be used as a neutralizer. Examples of the basic compound include, but are not limited to, hydroxides and carbonates of alkali metals or alkaline earth metals, ammonium compounds such as ammonia, and amines. These may be used alone, or two or more of these may be used in combination.

The conductive resin composition of the present invention has a viscosity at 25° C. of 50 to 8000 dPa·s, preferably 70 to 3000 dPa·s, and more preferably 100 to 2000 dPa·s. If the viscosity is less than 50 dPa·s, the composition may have poor adhesion to substrates due to poor drying, and may show deteriorated printing properties. Conversely, if the viscosity is more than 8000 dPa·s, the composition dries too rapidly, which is likely to cause clogging of the printing plate and formation of foams or pinholes, resulting in poor handleability.

The conditions for measuring viscosity are as described above.

The conductive resin composition of the present invention preferably has a thixotropic index (Ti) at 25° C. of 0.5 to 20, more preferably 1 to 20, still more preferably 1 to 15, and particularly preferably 1.5 to 15. The composition having a Ti of less than 0.5 is likely to cause ink dripping leading to blurry lines and letters, and is thus difficult to use as a printing ink. The composition having a Ti of more than 20 disadvantageously can cause poor leveling, and when used as a printing ink, is likely to print patterns having surface irregularities.

The conditions for measuring thixotropic index are as described above.

The conductive resin composition of the present invention preferably has a yield stress at 25° C. of 5 to 1000 Pa, and more preferably 10 to 500 Pa. The composition having a yield stress of less than 5 Pa flows even when it is left at rest, and cannot remain on the printing plate, 0.15 and therefore the composition cannot be printed. Conversely, the composition having a yield stress of more than 1000 Pa does not flow even when a force is applied, and therefore the composition cannot be printed.

The conditions for measuring yield stress are as described above.

The conductive resin composition of the present invention preferably does not have a flash point.

The composition not having a flash point, which has a greatly reduced risk of fire, is very easy to handle with high safety for transportation, storage, and disposal.

The water content in the conductive resin composition of the present invention is preferably but not limited to 30% by weight or more, more preferably 40% by weight or more, and still more preferably 50% by weight or more. When the water content is 30% by weight or more, the film performance is not affected by the type of organic solvent, which provides a high degree of formulation freedom.

The printing ink of the present invention contains the conductive resin composition of the present invention, and can be suitably used in printing means such as screen printing, offset printing, and pad printing. In particular, by adjusting the amount of thickener, the printing ink can achieve a higher viscosity while maintaining the dispersion stability of the conductive polymer, and therefore the printing ink can be suitably used for printed articles requiring high resolution. The above printing means, which do not require any complicated process, allow for easy patterning at low costs. Since the printing ink of the present invention contains a highly viscous conductive polymer and a thickener, the printing ink can be suitably used in screen printing, offset printing, and pad printing which require high viscosity. Further, the resulting coating has good appearance and excellent transparency.

The transparent conductive laminate of the present invention is obtained by printing the printing ink of the present invention on a substrate, and has a surface resistivity of 0.1 to 1000 Ω/sq and a total light transmittance of 50% or higher. By such printing, a transparent conductive film can be formed on the substrate.

The substrate is preferably a transparent substrate. The material of the transparent substrate is not particularly limited as long as it is transparent, and examples include glass, polyester resins such as polyethylene terephthalate (PET), polyethylene naphthalate, and modified polyesters; resins of polyolefins such as polyethylene (PE) resins, polypropylene (PP) resins, polystyrene resins, and cyclic olefin resins; vinyl resins such as polyvinyl chloride and polyvinylidene chloride; polyether ether ketone (PEEK) resins; polysulfone (PSF) resins; polyether sulfone (PES) resins; polycarbonate (PC) resins; polyamide resins; polyimide resins; acrylic resins; and triacetyl cellulose (TAC) resins.

The thickness of the transparent substrate is preferably but not limited to 10 to 10000 μm, and more preferably 25 to 5000 μm. Moreover, the total light transmittance of the transparent substrate is preferably but not limited to 60% or higher, and more preferably 80% or higher.

The transparent conductive laminate has a surface resistivity of 1000 Ω/sq or lower, and preferably 900 Ω/sq or lower. If the surface resistivity is higher than 1000 Ω/sq, sufficient conductivity may not be ensured. Since smaller surface resistivity is more preferred, the lower limit of the surface resistivity is, for example, but not limited to, 0.1 Ω/sq.

The total light transmittance of the transparent conductive laminate is 50% or higher, preferably 60% or higher, and more preferably 80% or higher, while the upper limit thereof is not particularly limited.

The method for producing the transparent conductive laminate of the present invention includes printing the printing ink of the present invention on a substrate. Specifically, the transparent conductive laminate may be produced by, for example, (I) a step of application by printing and (II) a formation step. Printing allows for patterning to provide a product having a non-conductive portion and a conductive portion that has conductive patterns.

The printing ink of the present invention is preferably applied to substrates by printing methods, such as screen printing, offset printing, or pad printing. The printing ink of the present invention may be directly applied to the substrate, or may be applied to a layer (e.g. a primer layer) that is previously formed on the substrate.

In addition, if necessary, the printing step (I) may be performed after the surface of the substrate is previously treated. The surface may be treated by, for example, corona treatment, plasma treatment, ITRO treatment, or flame treatment.

In the formation step (II), the ink printed on the substrate is heated at 150° C. or lower, whereby a transparent conductive film can be formed on at least one face of the substrate. The heat treatment may be carried out by any conventionally known method, for example, by using a fan oven, an infrared oven, or a vacuum oven. In cases where the ink used in the printing step (I) contains a solvent, the solvent is removed by the heat treatment.

The heat treatment is carried out at 150° C. or lower. If the temperature of the heat treatment is higher than 150° C., the types of substrates that can be used are limited, and substrates commonly used in transparent electrode films such as, for example, PET films, polycarbonate films, and acrylic films cannot be used. In the present invention, transparent conductive bodies having sufficient transparency and conductivity can be advantageously obtained by heat treatment even at a temperature of 150° C. or lower. The temperature of the heat treatment is preferably 50 to 140° C., and more preferably 60 to 130° C. The period of the heat treatment is preferably but not limited to 0.1 to 60 minutes, and more preferably 0.5 to 30 minutes.

The transparent conductive laminate of the present invention may be used in any application that requires transparency and conductivity. Examples include touch panels and touch sensors for various electronic devices such as TVs and mobile phones with liquid crystal, plasma, and field emission displays and the like, and transparent electrodes of display elements. The transparent conductive laminate can also be used in transparent electrodes, transparent heating elements, electroplating primers, and like applications for solar cells, electromagnetic wave shielding materials, electronic papers, electroluminescent light-controlling elements, and the like. Among these, the transparent conductive laminate is preferably used in touch panels for various electronic devices, transparent electrodes for driving liquid crystal displays, transparent electrodes for driving EL elements, transparent electrodes for driving electrochromic elements, electromagnetic wave shielding materials, transparent heating elements, and electroplating primers. In particular, the transparent conductive laminate can be suitably used in touch panels and touch sensors for various electronic devices.

### EXAMPLES

The present invention will be described below by reference to, but not limited to, examples. In the following description, the term “part(s)” and “%” refer to “part(s) by weight” and “% by weight”, respectively, unless otherwise specified.

### Preparation Example 1

### Conductive Polymer

A 10-L reaction vessel equipped with a stirrer and a nitrogen inlet was charged with 5508 g of ion-exchanged water and 492 g of an aqueous solution of 12.8% by weight polystyrene sulfonic acid (PSS) (Mw=56000), and the mixed solution was stirred for one hour at constant 25° C. while blowing nitrogen through the solution. This solution had a temperature of 25° C., an oxygen concentration of 0.5 mg/L, and a pH of 0.8 and was stirred at 300 rpm. The oxygen concentration was determined using a Knick Process Unit 73O₂ with an O₂ sensor of InPro 6000 series (produced by Mettler-Toledo International Inc.). Next, 25.4 g (179 mmol) of 3,4-ethylenedioxythiophene (EDOT), 0.45 g of Fe₂(SO₄)₃.3H₂O, 30 g of Na₂S₂O₈ were added to the solution to initiate a polymerization reaction. After 12-hour reaction at 25° C., 30 g of Na₂S₂O₈ was further added. After additional 12-hour reaction, the solution was treated using ion exchange resins (Lewatit S100H and Lewatit MP62) to give 4200 g of a highly viscous dark blue PEDOT/PSS (solid content 2.2%, viscosity 66 dPa·s, thixotropic index 3.3, yield stress 5.5 Pa, average particle size 330 nm (determined using a zetasizer Nano-S produced by Malvern; the average particle size is hereinafter referred to as particle size.))

### Preparation Example 2

### Conductive Polymer

The same procedure was performed as in Preparation Example 1, except that the pH used was 0.5, to give 4500 g of a highly viscous dark blue PEDOT/PSS (solid content 2.4%, viscosity 93 dPa·s, thixotropic index 4.1, yield stress 10.3 Pa, particle size 410 nm).

### Preparation Example 3

### Conductive Polymer

The same procedure was performed as in Preparation Example 1, except that the stirring rate used was 250 rpm, to give 4400 g of a highly viscous dark blue PEDOT/PSS (solid content 3.9%, viscosity 130 dPa·s, thixotropic index 3.9, yield stress 12.5 Pa, particle size 680 nm).

### Preparation Example 4

### Conductive Polymer

The same procedure was performed as in Preparation Example 1, except that the temperature used was 28° C., to give 5500 g of a highly viscous dark blue PEDOT/PSS (solid content 4.3%, viscosity 250 dPa·s, thixotropic index 6.3, yield stress 8.9 Pa, particle size 1050 nm).

### Preparation Example 5

### Conductive Polymer

The same procedure was performed as in Preparation Example 1, except that the reaction concentration was set at 5% by adjusting the amount of ion-exchanged water, to give 5950 g of a highly viscous dark blue PEDOT/PSS (solid content 4.8%, viscosity 290 dPa·s, thixotropic index 6.5, yield stress 15.5 Pa, particle size 2500 nm).

### Preparation Example 6

### Conductive Polymer

A 10-L reaction vessel equipped with a stirrer and a nitrogen inlet was charged with 2437 g of ion-exchanged water and 244 g of an aqueous solution of 12.8% by weight polystyrene sulfonic acid (PSS) (Mw=56000), and the resulting solution was stirred for one hour at constant 25° C. while blowing nitrogen through the solution. This solution had a temperature of 25° C., an oxygen concentration of 0.5 mg/L, and a pH of 0.5 and was stirred at 250 rpm. The oxygen concentration was determined using a Knick Process Unit 73O₂ with an O₂ sensor of InPro 6000 series (produced by Mettler-Toledo International Inc.). Next, 12.7 g (89 mmol) of 3,4-ethylenedioxythiophene (EDOT), 0.225 g of Fe₂(SO₄)₃.3H₂O, and 211 g of a 10% by weight H₂S₂O₈ aqueous solution were added to the solution to initiate a polymerization reaction. After 12-hour reaction at 25° C., 35 g of 10% by weight H₂S₂O₈ was further added. After additional 12-hour reaction, the solution was treated using ion exchange resins (Lewatit S100H and Lewatit MP62) to give 1800 g of a highly viscous dark blue PEDOT/PSS (solid content 1.1%, viscosity 45 dPa·s, thixotropic index 2.1, yield stress 2.5 Pa, particle size 80 nm).

In examples and comparative examples described later, the materials listed below were used in addition to the highly viscous PEDOT/PSS aqueous dispersions obtained in Preparation Examples 1 to 6.

(A) Conductive Polymer

Poly(3,4-ethylenedioxythiophene)/polystyrene sulfonic acid (Clevios PH500 produced by Heraeus K.K., conductivity 300 S/cm, solid content 1.0%, viscosity 0.3 dPa·s or less, thixotropic index 1, yield stress 0.5 Pa or less, particle size 55 nm)
Poly(3,4-ethylenedioxythiophene)/polystyrene sulfonic acid (produced by Agfa, freeze-dried product, solid content 90%) Polyaniline sulfonic acid (AQUAPASS produced by MITSUBISHI RAYON CO., LTD., solid content 5.0%, viscosity 10 dPa·s, thixotropic index 1.5, yield stress 1 Pa, particle size 500 nm)

(B) Conductivity Enhancer

Ethylene cyanohydrin (produced by Tokyo Chemical Industry Co., Ltd.)
Pyrazole (produced by Tokyo Chemical Industry Co., Ltd.)
Ethylene glycol (produced by Tokyo Chemical Industry Co., Ltd.)

(C) Binder

Polyester (Gabusen ES-210 produced by Nagase ChemteX Corporation, solid content 25%)
Methyl silicate oligomer (MKC silicate MS57 produced by Mitsubishi Chemical Corp., solid content 100%)
Polyolefin (HARDLEN EZ-2001 produced by TOYOBO CO., LTD., solid content 30%)

(D) Thickener

Crosslinkable polyacrylic acid (CARBOPOL ETD-2623 produced by B.F. Goodrich Company)
Polyvinylpyrrolidone (polyvinylpyrrolidone K-90 produced by NIPPON SHOKUBAI CO., LTD.)
Water-soluble polyacrylic acid (AQUALIC® L, H produced by NIPPON SHOKUBAI CO., LTD.)

Antioxidant

Tannic acid (produced by Ajinomoto OmniChem)
L-Ascorbic acid (produced by Wako Pure Chemical Industries, Ltd.)

Surfactant

Fluorinated surfactant (CAPSTONE FS-3100 produced by Du Pont Kabushiki Kaisha)

Cocamide propyl betaine (AMOGEN CB-H produced by DAI-ICHI KOGYO SEIYAKU CO., LTD.)

Polyether-modified polydimethylsiloxane (KF-6011 produced by Shin-Etsu Silicone)

Solvent

IPA (isopropyl alcohol) (produced by Wako Pure Chemical Industries, Ltd.)
Ethylene glycol (produced by Tokyo Chemical Industry Co., Ltd.)

Neutralizer

10% ammonia water (produced by Wako Pure Chemical Industries, Ltd.)

### Examples 1 to 24 and Comparative Examples 1 to 4

Conductive resin compositions were prepared by mixing ingredients in the weight ratios shown in Table 1 below. The amount of the thickener (D) shown in Table 1 was per 100 parts by weight of solids of the conductive polymer (A).

The highly viscous PEDOT/PSS aqueous dispersions obtained in Preparation Examples 1 to 6 and the conductive resin compositions obtained in Examples 1 to 24 and Comparative Examples 1 to 4 were measured for viscosity, thixotropic index, and yield stress by the methods described below. In addition, the conductive resin compositions obtained in Examples 1 to 24 and Comparative Examples 1 to 4 were measured for liquid appearance, water content, flash point, coating appearance, surface resistivity (SR), total light transmittance (Tt)/haze value, adhesion, resolution, and heat resistance by the methods described below. Table 2 shows the results.

### Viscosity

Samples were put into a thermostatic bath and kept at 25° C., and viscosity was measured with a B-type viscometer (B-type viscometer BM produced by TOKI SANGYO CO., LTD., rotational frequency 6 rpm, No. 4 rotor).

### Thixotropic Index

A ratio of a viscosity η₁ at a shear rate of 1 (1/s) to a viscosity η₁₀ at a shear rate 10 (1/s) (Ti value=η₁/η₁₀), as determined at 25° C. using a rheometer (AR-G2 produced by TA Instruments) was calculated.

### Yield Stress

Yield stress was calculated by measuring stress at 25° C. using a rheometer (AR-G2 produced by TA Instruments) while varying the shear rate over the range of 0.01 (1/s) to 100 (1/s), followed by fitting the Casson equation:

√stress=√viscosity·√shear rate+√yield stress.

### Liquid Appearance

The conductive resin compositions were put into a glass container, and the container was sealed. After one hour, the compositions were visually observed to evaluate the liquid appearance according to the following criteria:

Good: No precipitate observed;
Poor: Precipitate observed.

### Water Content

Water content was calculated from the amounts of the ingredients.

### Flash Point

Flash point was measured according to JIS K 2265.

### Coating Appearance

A light for visual inspection was placed on the back side of the transparent conductive body, and the appearance properties of the transparent conductive laminates were evaluated on the following two-point scale:

Good: Smooth coating uniformly formed;
Acceptable: Coating containing agglomerates or cissing and non-uniformly formed.

### Surface Resistivity (SR)

The conductive resin compositions were applied to a substrate (material: soda lime glass, produced by Sekiya Rika Co., Ltd., 100 mm×100 mm×2 mm, total light transmittance 91.0%) with a bar coater, and then heated in a fan oven at 130° C. for 5 minutes to form a transparent conductive film on one side of the substrate. In this manner, transparent conductive laminates were obtained. The conductive laminates were measured for surface resistivity using with a resistivity meter (Loresta GP MCP-T600 produced by Mitsubishi Chemical Corp.).

### Total Light Transmittance (Tt)/Haze Value

The transparent conductive laminates were measured with a haze computer HGM-2B produced by Suga Test Instruments Co., Ltd. in accordance with JIS K 7150.

### Adhesion (Cross-Cut Test)

A cross-cut peeling test was performed in accordance with JIS K 5400.

### Resolution

Wiring patterns in the range of 0.02 to 10 mm were printed on a soda lime glass substrate (produced by Sekiya Rika Co., Ltd., 100 mm×100 mm×2 mm, total light transmittance 91.0%) using the conductive resin compositions by screen printing. The formed patterns were observed by a microscope, and the smallest width of a line drawn without defects was defined as resolution.

### Heat Resistance

The transparent conductive films of the transparent conductive laminates were measured for initial surface resistivity and surface resistivity after storage at 80° C. for 240 hours by the above method for measuring surface resistivity. The rate of increase in surface resistivity after storage [(surface resistivity after storage)/(initial surface resistivity)] was then calculated and evaluated on the following three-point scale:

Good: The rate of increase in surface resistivity is less than 1.5;
Acceptable: The rate of increase in surface resistivity is at least 1.5 but less than 2.0;
Poor: The rate of increase in surface resistivity is 2.0 or more.

TABLE 1

| | (A) Conductive polymer | | | | (B) Conductivity | | | | | | | | | | | | | |
|---|---|---|---|---|---|---|---|---|---|---|---|---|---|---|---|---|---|---|
| | | Solid | | | enhancer | | (C) Binder | | (D) Thickener | | Antioxidant | | Surfactant | | Solvent | | Neutralizer | |
| | | content | Concen- | Amount | | Amount | | Amount | | Amount | | Amount | | Amount | | Amount | | Amount |
| | Type | (%) | tration | (part) | Type | (part) | Type | (part) | Type | (part) | Type | (part) | Type | (part) | Type | (part) | Type | (part) |
| Example 1 | Production | 2.2 | Non- | 4.6 | Ethylene | 0.4 | Polyester | 0.2 | CARBOPOL | 0.01 | Tannic | 0.1 | CAPSTONE | 0.02 | IPA | 3 | — | — |
| | Example 1 | | concentrated | | cyanohydrin | | | | ETD-2623 | | acid | | FS-3100 | | | | | |
| Example 2 | Production | 2.2 | Non- | 4.6 | Ethylene | 0.4 | Polyester | 0.2 | CARBOPOL | 0.01 | Tannic | 0.1 | CAPSTONE | 0.02 | Ethanol | 3 | — | — |
| | Example 1 | | concentrated | | cyanohydrin | | | | ETD-2623 | | acid | | FS-3100 | | | | | |
| Example 3 | Production | 2.2 | Non- | 4.6 | Ethylene | 0.4 | Poly- | 0.3 | CARBOPOL | 0.01 | Tannic | 0.1 | CAPSTONE | 0.02 | IPA | 3.2 | — | — |
| | Example 1 | | concentrated | | cyanohydrin | | urethane | | ETD-2623 | | acid | | FS-3100 | | | | | |
| Example 4 | Production | 2.2 | Non- | 4.6 | Ethylene | 0.4 | Polyester | 0.4 | CARBOPOL | 0.06 | Tannic | 0.1 | CAPSTONE | 0.02 | IPA | 3 | — | — |
| | Example 1 | | concentrated | | cyanohydrin | | | | ETD-2623 | | acid | | FS-3100 | | | | | |
| Example 5 | Production | 2.4 | Non- | 4.5 | Pyrazole | 0.4 | Polyester | 0.4 | Polyvinyl- | 0.01 | — | — | CAPSTONE | 0.02 | IPA | 3 | — | — |
| | Example 2 | | concentrated | | | | | | pyrrolidone | | | | FS-3100 | | | | | |
| | | | | | | | | | K-90 | | | | | | | | | |
| Example 6 | Production | 2.4 | Non- | 4.5 | Pyrazole | 0.4 | Polyester | 0.4 | Polyvinyl- | 0.06 | — | — | CAPSTONE | 0.02 | IPA | 3 | — | — |
| | Example 2 | | concentrated | | | | | | pyrrolidone | | | | FS-3100 | | | | | |
| | | | | | | | | | K-90 | | | | | | | | | |
| Example 7 | Production | 3.9 | Non- | 3.5 | Ethylene | 5.5 | Methyl | 0.1 | AQUALIC | 0.01 | L-Ascor- | 0.16 | AMOGEN | 0.02 | — | — | — | — |
| | Example 3 | | concentrated | | glycol | | silicate | | | | bic acid | | CB-H | | | | | |
| | | | | | | | oligomer | | | | | | | | | | | |
| Example 8 | Production | 3.9 | Non- | 3.5 | Ethylene | 0.4 | Methyl | 0.1 | AQUALIC | 0.01 | L-Ascor- | 0.16 | AMOGEN | 0.02 | IPA | 5.1 | — | — |
| | Example 3 | | concentrated | | glycol | | silicate | | | | bic acid | | CB-H | | | | | |
| | | | | | | | oligomer | | | | | | | | | | | |
| Example 9 | Production | 3.9 | Non- | 3.5 | Ethylene | 6 | Methyl | 0.1 | AQUALIC | 0.06 | L-Ascor- | 0.16 | CAPSTONE | 0.02 | — | — | — | — |
| | Example 3 | | concentrated | | glycol | | silicate | | | | bic acid | | FS-3100 | | | | | |
| | | | | | | | oligomer | | | | | | | | | | | |
| Example 10 | Production | 4.3 | Non- | 3.2 | Ethylene | 0.3 | Polyolefin | 0.45 | Polyvinyl- | 0.01 | Tannic | 0.15 | CAPSTONE | 0.02 | Solution | 5 | — | — |
| | Example 4 | | concentrated | | glycol | | | | pyrrolidone | | acid | | FS-3100 | | of water/ | | | |
| | | | | | | | | | K-90 | | | | | | ethylene | | | |
| | | | | | | | | | | | | | | | glycol = | | | |
| | | | | | | | | | | | | | | | 50:50 | | | |
| Example 11 | Production | 4.3 | Non- | 3.2 | Ethylene | 0.3 | Polyolefin | 0.45 | Polyvinyl- | 0.01 | Tannic | 0.15 | CAPSTONE | 0.02 | Solution | 5 | — | — |
| | Example 4 | | concentrated | | glycol | | | | pyrrolidone | | acid | | FS-3100 | | of water/ | | | |
| | | | | | | | | | K-90 | | | | | | IPA = | | | |
| | | | | | | | | | | | | | | | 50:50 | | | |
| Example 12 | Production | 4.3 | Non- | 3.2 | Ethylene | 0.3 | Polyolefin | 0.45 | Polyvinyl- | 0.01 | Tannic | 0.15 | CAPSTONE | 0.02 | Solution | 5 | — | — |
| | Example 4 | | concentrated | | glycol | | | | pyrrolidone | | acid | | FS-3100 | | of water/ | | | |
| | | | | | | | | | K-90 | | | | | | ethylene | | | |
| | | | | | | | | | | | | | | | glycol = | | | |
| | | | | | | | | | | | | | | | 50:50 | | | |
| Example 13 | Production | 4.8 | Non- | 2.8 | Pyrazole | 0.3 | Polyester | 0.3 | CARBOPOL | 0.01 | Tannic | 0.15 | CAPSTONE | 0.02 | Ethylene | 4 | — | — |
| | Example 5 | | concentrated | | | | | | ETD-2623 | | acid | | FS-3100 | | glycol | | | |
| Example 14 | Production | 4.8 | Non- | 2.8 | Pyrazole | 0.3 | Polyester | 0.3 | CARBOPOL | 0.06 | Tannic | 0.15 | CAPSTONE | 0.02 | Ethylene | 4 | — | — |
| | Example 5 | | concentrated | | | | | | ETD-2623 | | acid | | FS-3100 | | glycol | | | |
| Example 15 | Freeze- | 90 | Concentrated | 0.2 | Ethylene | 2 | Polyester | 0.6 | CARBOPOL | 0.02 | — | — | CAPSTONE | 0.03 | — | — | — | — |
| | dried | | | | glycol | | | | ETD-2623 | | | | FS-3100 | | | | | |
| | product | | | | | | | | | | | | | | | | | |
| Example 16 | Clevios | 1 | Non- | 10 | Ethylene | 0.3 | Polyester | 0.26 | AQUALIC | 0.06 | — | — | CAPSTONE | 0.02 | IPA | 2 | — | — |
| | PH500 | | concentrated | | cyanohydrin | | | | | | | | FS-3100 | | | | | |
| Example 17 | AQUA | 5 | Non- | 2 | Ethylene | 0.3 | Polyester | 0.26 | AQUALIC | 0.06 | — | — | CAPSTONE | 0.02 | Solution | 10 | — | — |
| | PASS | | concentrated | | cyanohydrin | | | | | | | | FS-3100 | | of IPA/ | | | |
| | | | | | | | | | | | | | | | water = | | | |
| | | | | | | | | | | | | | | | 1:4 | | | |
| Example 18 | Clevios | 1 | Non- | 4.6 | Ethylene | 0.4 | Polyester | 0.4 | AQUALIC | 0.005 | Tannic | 0.1 | CAPSTONE | 0.01 | IPA | 5 | — | — |
| | PH500 | | concentrated | | cyanohydrin | | | | | | acid | | FS-3100 | | | | | |
| Example 19 | Production | 1.1 | Non- | 46.5 | Ethylene | 20 | Polyester | 3 | AQUALIC | 0.05 | Tannic | 0.415 | KF-6011 | 0.08 | — | — | — | — |
| | Example 6 | | concentrated | | glycol | | | | | | acid | | | | | | | |
| Example 20 | Production | 1.1 | Non- | 46.5 | Ethylene | 20 | Polyester | 3 | AQUALIC | 0.3 | Tannic | 0.415 | KF-6011 | 0.08 | — | — | — | — |
| | Example 6 | | concentrated | | glycol | | | | | | acid | | | | | | | |
| Example 21 | Production | 1.1 | Non- | 46.5 | Ethylene | 20 | Polyester | 3 | AQUALIC | 0.05 | Tannic | 0.415 | KF-6011 | 0.08 | — | — | 10% | 0.5 |
| | Example 6 | | concentrated | | glycol | | | | | | acid | | | | | | Ammonia | |
| | | | | | | | | | | | | | | | | | water | |
| Example 22 | Production | 1.1 | Non- | 46.5 | Ethylene | 20 | Polyester | 3 | AQUALIC | 0.511 | Tannic | 0.415 | KF-6011 | 0.08 | — | — | — | — |
| | Example 6 | | concentrated | | glycol | | | | | | acid | | | | | | | |
| Example 23 | Production | 1.1 | Non- | 46.5 | Ethylene | 20 | Polyester | 3 | AQUALIC | 0.767 | Tannic | 0.415 | KF-6011 | 0.10 | — | — | — | — |
| | Example 6 | | concentrated | | glycol | | | | | | acid | | | | | | | |
| Example 24 | Production | 1.1 | Non- | 46.5 | Ethylene | 50 | Polyester | 3 | AQUALIC | 0.511 | Tannic | 0.415 | KF-6011 | 0.08 | — | — | — | — |
| | Example 6 | | concentrated | | glycol | | | | | | acid | | | | | | | |
| Comparative | Clevios | 1 | Non- | 10 | Ethylene | 0.3 | Polyester | 0.3 | CARBOPOL | 0.01 | — | — | CAPSTONE | 0.02 | IPA | 2 | — | — |
| Example 1 | pH500 | | concentrated | | cyanohydrin | | | | ETD-2623 | | | | FS-3100 | | | | | |
| Comparative | Clevios | 1 | Non- | 10 | Ethylene | 0.3 | Polyester | 0.26 | — | — | — | — | CAPSTONE | 0.02 | IPA | 2 | — | — |
| Example 2 | PH500 | | concentrated | | cyanohydrin | | | | | | | | FS-3100 | | | | | |
| Comparative | Clevios | 1 | Non- | 4.6 | Ethylene | 0.4 | Polyester | 0.4 | — | — | Tannic | 0.1 | CAPSTONE | 0.01 | IPA | 5 | — | — |
| Example 3 | PH500 | | concentrated | | cyanohydrin | | | | | | acid | | FS-3100 | | | | | |
| Comparative | Freeze- | 90 | Concentrated | 2 | Ethylene | 1.7 | Polyester | 4 | CARBOPOL | 1.08 | Tannic | 0.01 | CAPSTONE | 0.28 | — | — | — | — |
| Example 4 | dried | | | | glycol | | | | ETD-2623 | | acid | | FS-3100 | | | | | |
| | product | | | | | | | | | | | | | | | | | |

Also served as solvent

TABLE 2

| | | | | | Water | Flash | |
|---|---|---|---|---|---|---|---|
| | Viscosity | Thixotropic | Yield stress | Liquid | content | point | Coating |
| | (dPa · s) | index | (Pa) | appearance | (%) | (° C.) | appearance |
| Example 1 | 400 | 5.8 | 15.5 | Good | 56.3 | 28 | Good |
| Example 2 | 400 | 5.9 | 15.6 | Good | 56.3 | 24 | Good |
| Example 3 | 410 | 5.8 | 15.7 | Good | 54.5 | 27 | Good |
| Example 4 | 510 | 10.3 | 21.0 | Good | 56.1 | 28 | Good |
| Example 5 | 390 | 6.6 | 13.3 | Good | 56.5 | 28 | Good |
| Example 6 | 700 | 9.8 | 25.3 | Good | 56.1 | 27 | Good |
| Example 7 | 890 | 7.9 | 24.8 | Good | 36.3 | None | Good |
| Example 8 | 790 | 7.8 | 19.0 | Good | 36.3 | 25 | Good |
| Example 9 | 1020 | 12.9 | 30.0 | Good | 36.1 | None | Good |
| Example 10 | 1250 | 10.9 | 28.4 | Good | 61.1 | None | Good |
| Example 11 | 1230 | 10.1 | 27.9 | Good | 61.1 | 29 | Good |
| Example 12 | 1650 | 13.8 | 32.2 | Good | 60.7 | None | Good |
| Example 13 | 1890 | 14.9 | 31.5 | Good | 40.3 | None | Good |
| Example 14 | 2500 | 23.9 | 41.5 | Good | 40.0 | None | Good |
| Example 15 | 3000 | 30.1 | 48.8 | Acceptable | 14.5 | None | Acceptable |
| Example 16 | 250 | 4.5 | 9.5 | Acceptable | 79.8 | 30 | Acceptable |
| Example 17 | 240 | 4.4 | 9.0 | Acceptable | 79.8 | 30 | Acceptable |
| Example 18 | 55 | 1.8 | 1.8 | Good | 45.8 | 26 | Good |
| Example 19 | 350 | 6.0 | 12.9 | Good | 68.5 | None | Good |
| Example 20 | 600 | 9.0 | 17.7 | Good | 68.2 | None | Good |
| Example 21 | 600 | 6.5 | 13.5 | Good | 68.7 | None | Good |
| Example 22 | 1000 | 12.4 | 29.8 | Good | 68.0 | None | Good |
| Example 23 | 1550 | 13.8 | 31.9 | Good | 67.8 | None | Good |
| Example 24 | 800 | 10.0 | 25.5 | Good | 47.7 | None | Good |
| Comparative | 40 | 1.4 | 1.8 | Good | 80.3 | 32 | Good |
| Example 1 | | | | | | | |
| Comparative | 5 | 1.2 | 1.1 | Good | 80.2 | 32 | Good |
| Example 2 | | | | | | | |
| Comparative | 15 | 1 | 1.1 | Good | 45.8 | 26 | Good |
| Example 3 | | | | | | | |
| Comparative | Unmeasurable | Unmeasurable | Unmeasurable | Poor | 30.9 | None | Not |
| Example 4 | | | | | | | coatable |

| | SR | Tt | Haze | | Resolution | Heat |
|---|---|---|---|---|---|---|
| | (Ω/□) | (%) | (%) | Adhesion | (mm) | resistance |
| Example 1 | 200 | 83.0 | 1.5 | 10 | 0.10 | Good |
| Example 2 | 200 | 83.0 | 1.5 | 10 | 0.10 | Good |
| Example 3 | 200 | 82.7 | 1.7 | 8 | 0.10 | Good |
| Example 4 | 190 | 82.3 | 1.7 | 10 | 0.08 | Good |
| Example 5 | 240 | 83.1 | 1.6 | 10 | 0.10 | Acceptable |
| Example 6 | 220 | 83.0 | 2.0 | 10 | 0.08 | Acceptable |
| Example 7 | 205 | 82.0 | 1.9 | 10 | 0.10 | Good |
| Example 8 | 250 | 83.0 | 2.5 | 10 | 0.10 | Good |
| Example 9 | 190 | 82.0 | 1.8 | 10 | 0.06 | Good |
| Example 10 | 180 | 81.1 | 2.2 | 10 | 0.07 | Good |
| Example 11 | 185 | 80.9 | 2.5 | 10 | 0.07 | Good |
| Example 12 | 160 | 79.9 | 2.8 | 10 | 0.05 | Good |
| Example 13 | 150 | 78.0 | 3.0 | 10 | 0.03 | Good |
| Example 14 | 140 | 76.9 | 3.8 | 10 | 0.02 | Good |
| Example 15 | 135 | 72 | 21.9 | 6 | 0.02 | Acceptable |
| Example 16 | 500 | 87 | 1.9 | 8 | 0.20 | Acceptable |
| Example 17 | 600 | 85.5 | 2.1 | 8 | 0.20 | Acceptable |
| Example 18 | 500 | 87.0 | 1.5 | 10 | 0.80 | Good |
| Example 19 | 280 | 84.5 | 1.4 | 10 | 0.10 | Good |
| Example 20 | 270 | 83.9 | 1.8 | 10 | 0.08 | Good |
| Example 21 | 300 | 83 | 2.9 | 10 | 0.09 | Good |
| Example 22 | 300 | 84 | 1.5 | 10 | 0.07 | Good |
| Example 23 | 320 | 84.1 | 2.0 | 10 | 0.05 | Good |
| Example 24 | 310 | 84.5 | 1.0 | 10 | 0.09 | Good |
| Comparative | 350 | 87.5 | 0.8 | 10 | 2.00 | Acceptable |
| Example 1 | | | | | | |
| Comparative | 300 | 86.8 | 0.5 | 10 | 10.00 | Acceptable |
| Example 2 | | | | | | |
| Comparative | 500 | 86.9 | 1.0 | 10 | 2.00 | Good |
| Example 3 | | | | | | |
| Comparative | Not | Not | Not | Not | Not | Not |
| Example 4 | coatable | coatable | coatable | coatable | coatable | coatable |

The results of Preparation Examples 1 to 6 demonstrated that PEDOT/PSSs having predetermined viscosities, thixotropic indexes, and yield stresses can be synthesized by varying the pH, stirring rate, temperature, and concentration conditions.

The results of Examples 1 to 24 and Comparative Examples 1 to 4 demonstrated that the transparent conductive laminates of the examples are superior in appearance or haze, adhesion, and resolution to the comparative examples.

The conductive resin compositions of the present invention, which contain highly viscous conductive polymers, showed sufficient viscosity properties even when only a small amount of thickener was added. Further, the conductive resin compositions, when made more viscous than usual, formed no precipitate due to the addition of a thickener and no cissing during application, and therefore exhibited lower haze values than those in the comparative examples.

Since the amount of thickener in the conductive resin composition of the present invention can be adjusted to provide a very highly viscous printing ink while maintaining the dispersion stability of the conductive polymer, fine patterns in the range of 100 μm or less were formed from the conductive resin compositions.

Further, owing to the balanced viscosity, thixotropic index, and yield stress, the conductive resin composition does not form precipitates even when a conventional amount of thickener is added.

### INDUSTRIAL APPLICABILITY

The conductive resin composition of the present invention can be suitably used in production of transparent conductive laminates.

1. A conductive resin composition, comprising:
(A) a conductive polymer;
(B) a conductivity enhancer;
(C) a binder; and
(D) a thickener,
the composition having a viscosity at 25° C. of 50 to 8000 dPa·s, and containing the thickener (D) in an amount of less than 200 parts by weight per 100 parts by weight of solids of the conductive polymer (A).

2. The conductive resin composition according to claim 1,
wherein the conductive polymer (A) is a composite of poly(3,4-ethylenedioxythiophene) and polystyrene sulfonic acid.

3. The conductive resin composition according to claim 1,
wherein the conductive polymer (A) is a 1% to 5% by weight conductive polymer aqueous dispersion having a viscosity at 25° C. of 5 to 500 dPa·s.

4. The conductive resin composition according to claim 3,
wherein the conductive polymer aqueous dispersion is obtained without concentration.

5. The conductive resin composition according to claim 1,
